(19) United States
(12) Patent Application Publication
(10) Pub. No.: US 2010/0167688 A1
(43) Pub. Date: Jul. 1, 2010

(54) ARRANGEMENT AT A MOBILE COMMUNICATION SYSTEM

(76) Inventor: Mikael Langstrom, Umea (SE)

Correspondence Address: Pequignot + Myers LLC, 140 Marine View Avenue, Suite 220, Solana Beach, CA, 92075, US

(21) Appl. No.: 12/466,538

(22) Filed: May 15, 2009

Related U.S. Application Data
(63) Continuation of application No. 10/333,075, filed on Sep. 29, 2003, now abandoned.

(30) Foreign Application Priority Data
Jul. 21, 2000 (SE) 0002743.3

(51) Int. Cl. H04M 11/04

(52) U.S. Cl. 455/404.2

(57) ABSTRACT

Mobile telephones are often used during transport involving risk, and in that case to call for help. However, the mobile telephone may be blocked by the perpetrator of a crime. The present invention solves this problem since, whether it is in use or not, a mobile telephone continuously emits a signal. An alarm will be triggered in the absence of a signal at a receiving unit, which receiving unit may be an alarm centre or an Internet system.

This application is a continuation of and claims priority to co-pending U.S. patent application Ser. No. 10/333,075, filed Sep. 29, 2003, entitled ARRANGEMENT AT A MOBILE COMMUNICATION SYSTEM, which is a national stage filing under 35 U.S.C. §371 of, and claims priority to, international patent application no. PCT/SE01/01656, filed Jul. 20, 2001, which claims priority to Swedish patent application no. 0002743.3, filed Jul. 21, 2000, priority to each of which is claimed and each of which is hereby incorporated by reference in its entirety.

The present invention relates to a mobile communication system which may be of any type whatsoever. Such a system is GSM, for instance. A mobile telephone may be useful when transporting valuable goods or during some other transport or situation that may involve danger. In such a situation the perpetrator of a crime may very easily block signals emitted from the mobile telephone so that the owner of the mobile telephone is completely isolated. This is a considerable disadvantage.

The purpose of the present invention is to provide a remedy for the above-mentioned situation where a mobile telephone can be blocked. In accordance with the invention a signal is continuously emitted by the mobile telephone, or through mobile telephones, whether it is in use or not. Said signal is received at the central venue of the mobile telephone system by the equipment placed in or built into this central venue, and where the absence of a signal triggers an indication such as an alarm. In accordance with a further development of the present invention the continuously emitted signal is transmitted to an optional communication medium such as the Internet, in which case a special transmission device is used and the signal is supplied in the optional communication system to an alarm centre which immediately receives an alarm in the absence of a signal. The continuous signal may contain data as to the owner of the mobile telephone and may also define positional data. The continuous signal in a mobile telephone or other unit having similar capabilities may be emitted by a transmitter (of known type), and said transmitter may cooperate with a positioning system, e.g. the GPS system, thereby obtaining positional data so that when the transmitter emits signals the signal also contains data as to position.

In an arrangement in accordance with the present invention, thus, one or more of the mobile telephones contains a transmitter that continuously emits a signal whether the mobile telephone is being used or not. The transmitter is also suitably such that it receives positional data from a positioning system, e.g. the GPS system, so that a signal emitted continuously from the mobile telephone or other unit having similar capabilities, includes data as to position and information as to who owns the mobile telephone.

With known equipment such a signal can be blocked without any great difficulty. Should this occur the equipment receiving the signal in the central unit of the mobile telephone system will trigger an indication in the form of an alarm. However, this can be greatly facilitated by arranging a transmitting device from the mobile telephone system to an optional communication system such as the Internet, so that the continuous signal from a mobile telephone or other unit having similar capabilities is transmitted to a desired unit in the optional communication system and the desired unit may be an alarm centre that, in the absence of a signal, triggers an indication such as an alarm. The requisite measures can be taken with the aid of this alarm. Since the signal has been continuous the alarm centre has received continuous information as to the ownership and position of the mobile telephone. A suitable type of data medium for the continuous signal may be a so-called USSD signal or GPRS-IP packet, but it should be evident that considerable freedom exists to choose suitable signals.

Two embodiments of a device in accordance with the invention will be described by way of example in the following with reference to the accompanying drawings in which

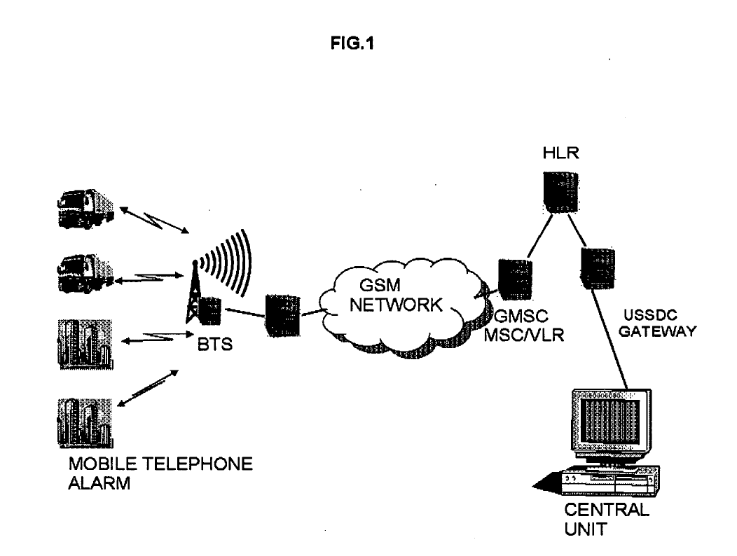

FIG. 1 shows the USSD flow in a PLMN system,

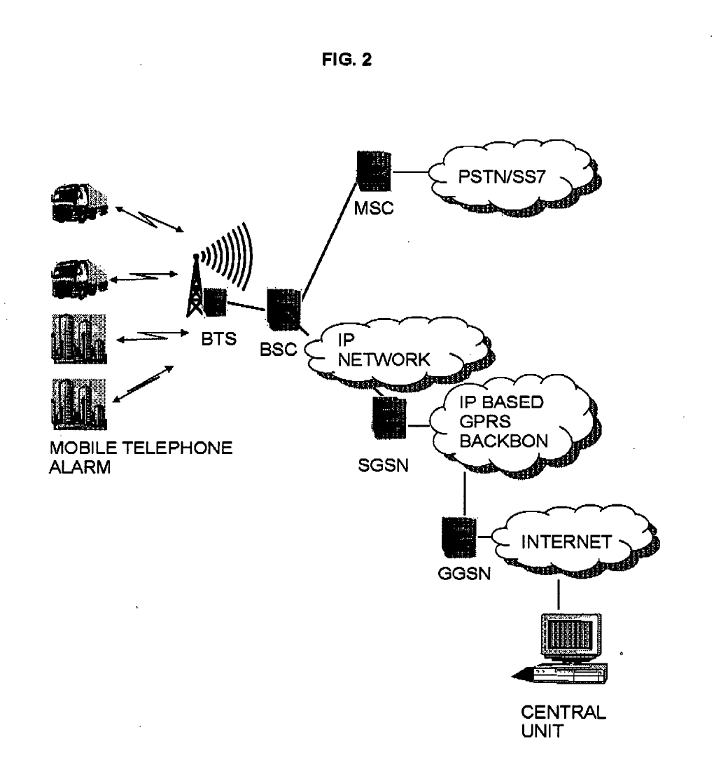

FIG. 2 shows the GPRS flow in a PLMN system,

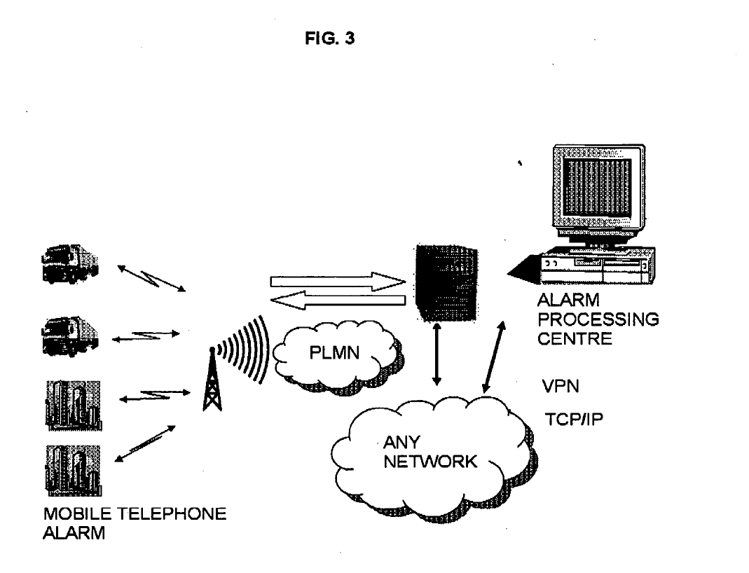

FIG. 3 shows an overall diagram of the arrangement,

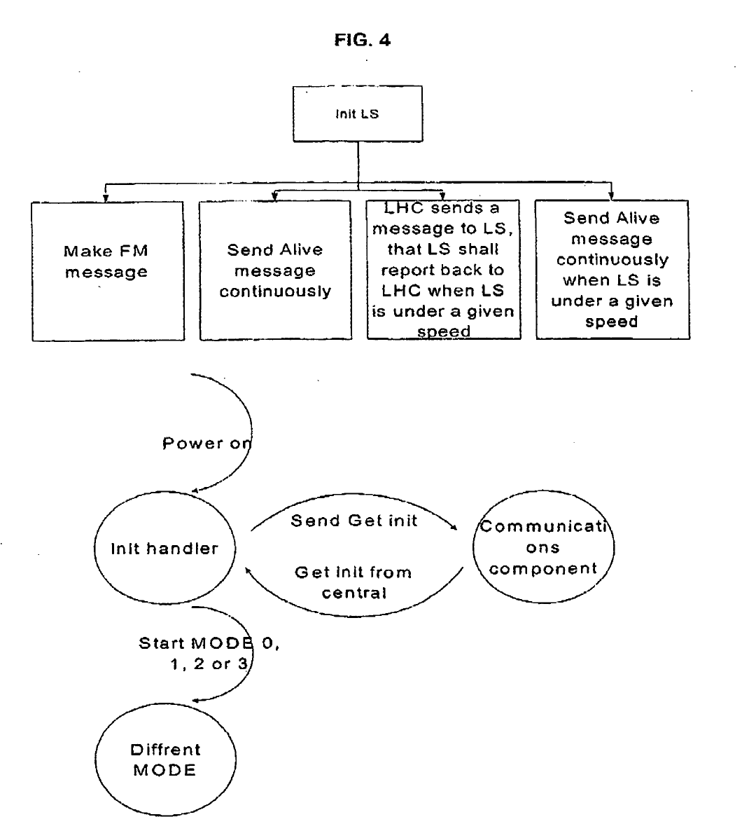

FIG. 4 shows an alarm component at initiation,

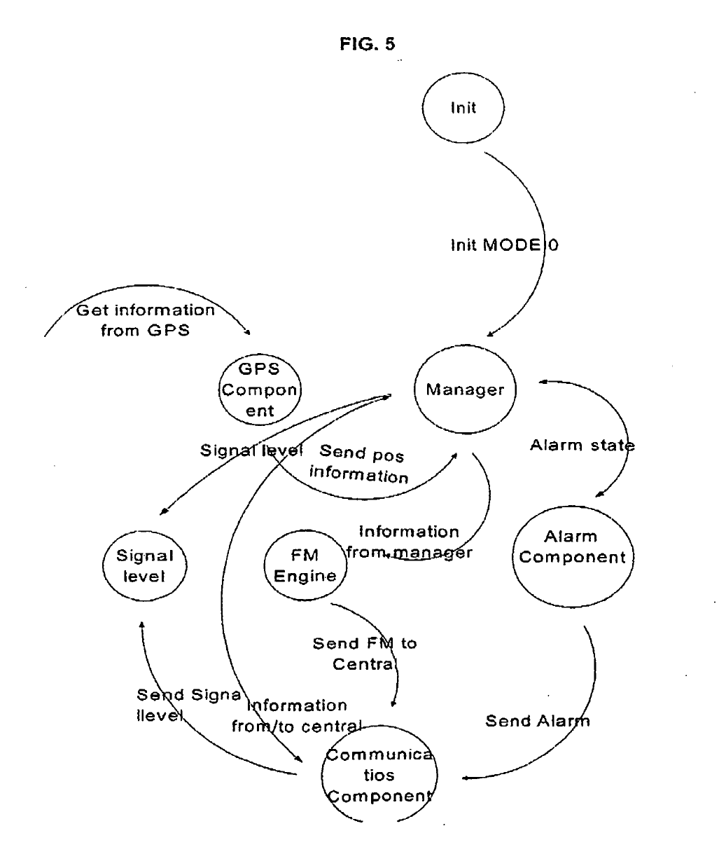

FIG. 5 shows processes upon initiation in accordance with Mode 0,

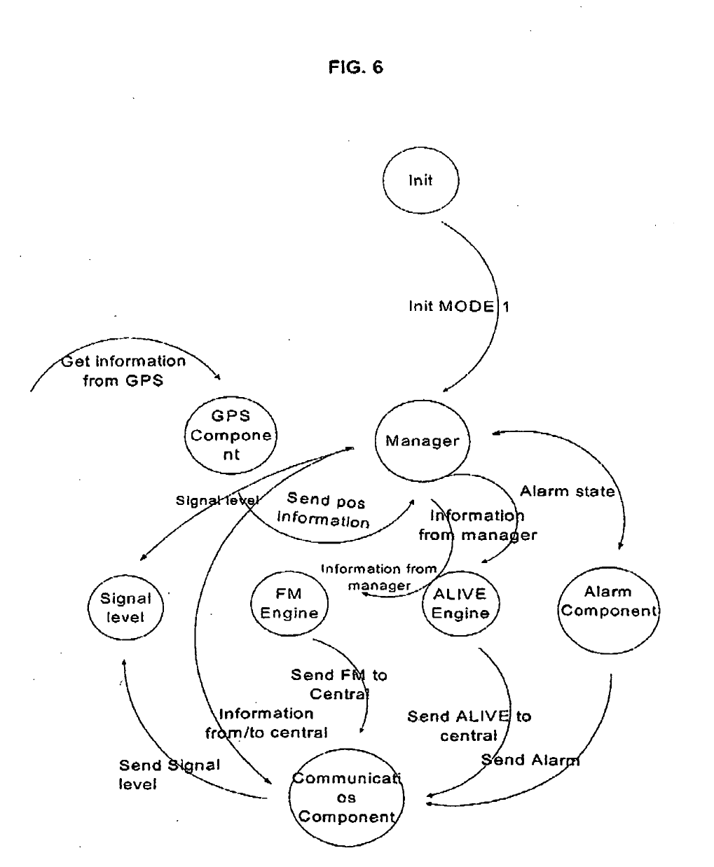

FIG. 6 shows processes upon initiation in accordance with Mode 1,

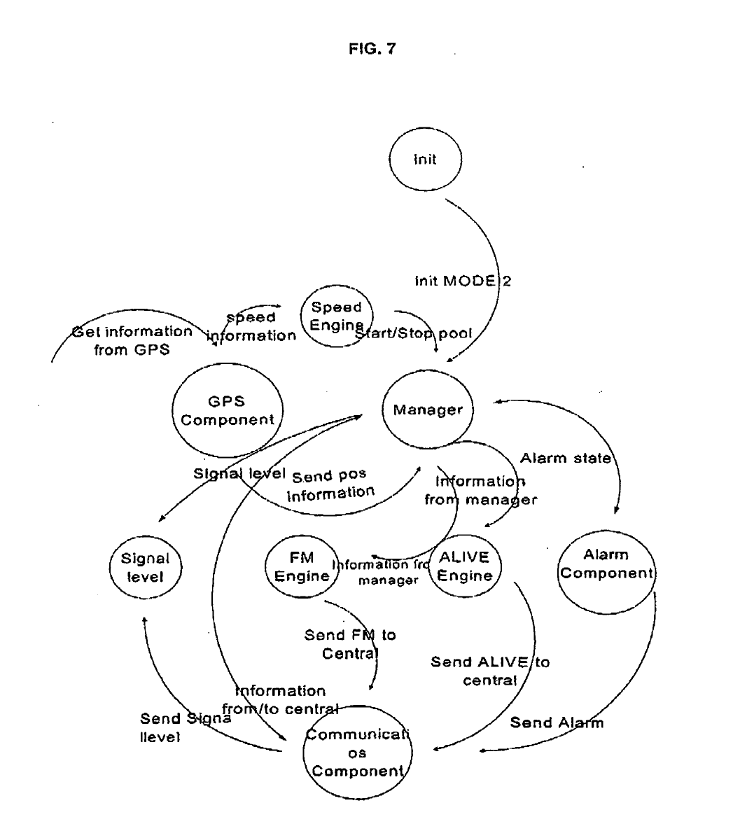

FIG. 7 shows processes upon initiation in accordance with Mode 2,

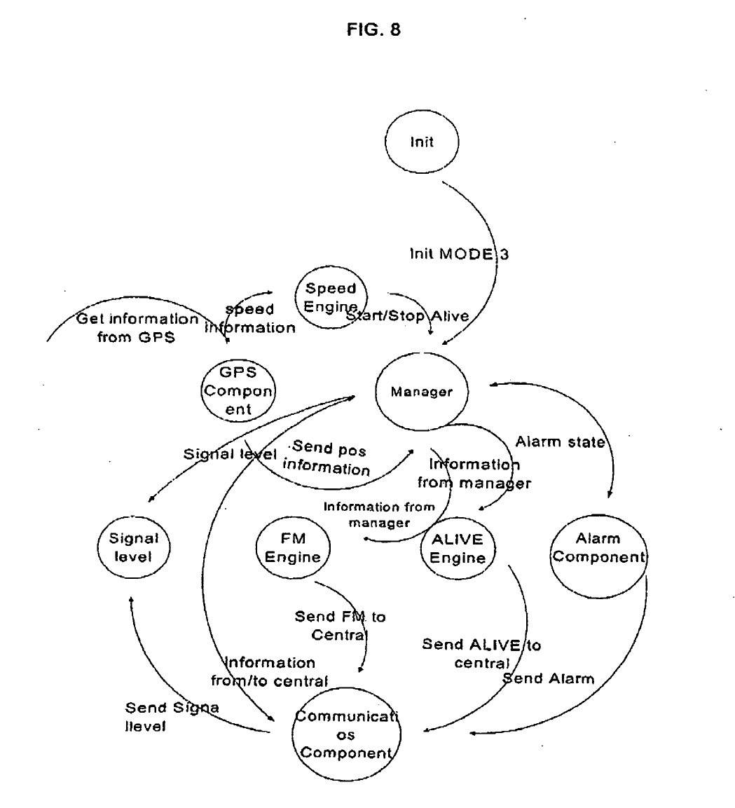

FIG. 8 shows processes upon initiation in accordance with Mode 3,

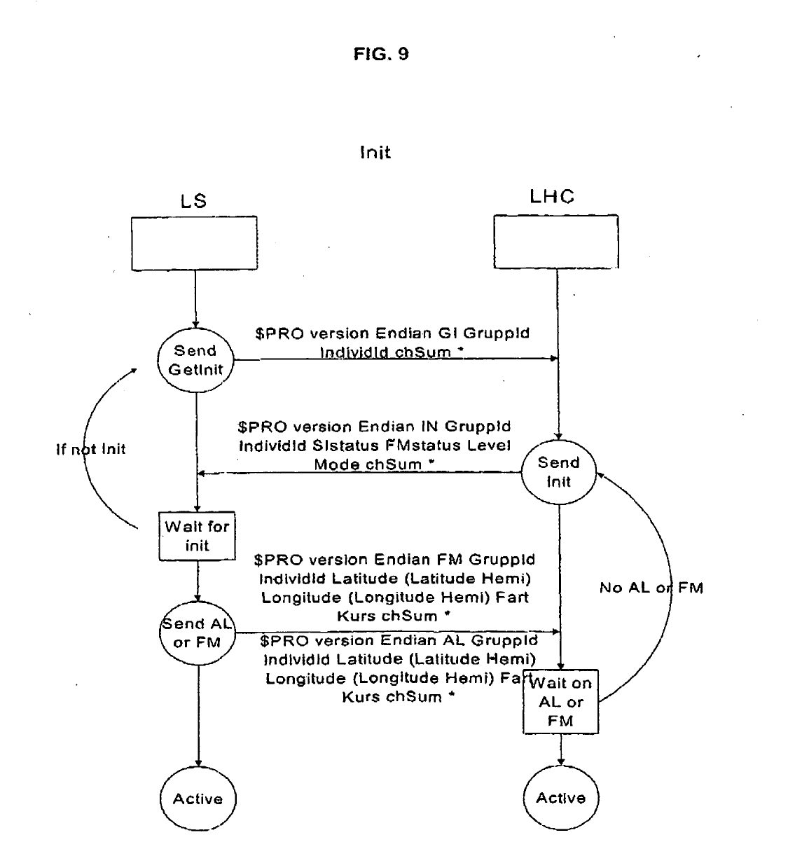

FIG. 9 shows data flow between the Mobile telephone alarm and the Alarm handling centre,

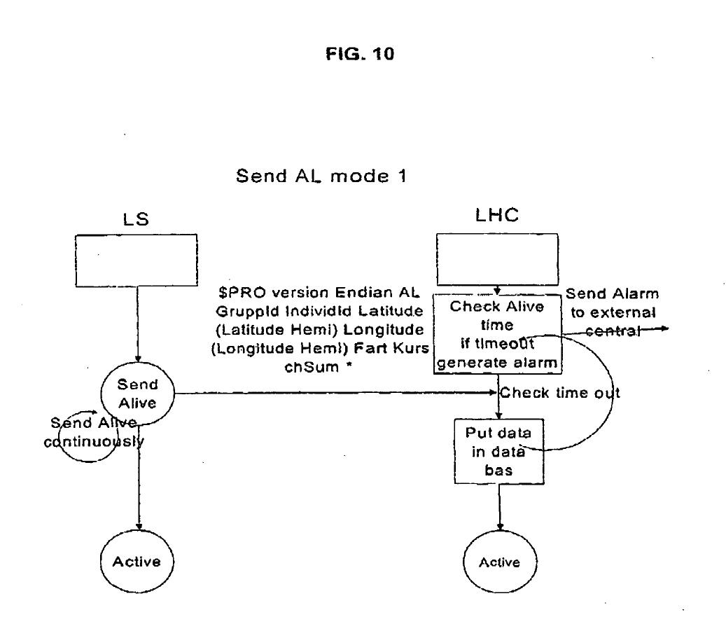

FIG. 10 shows data flow in accordance with FIG. 9 in Mode 1,

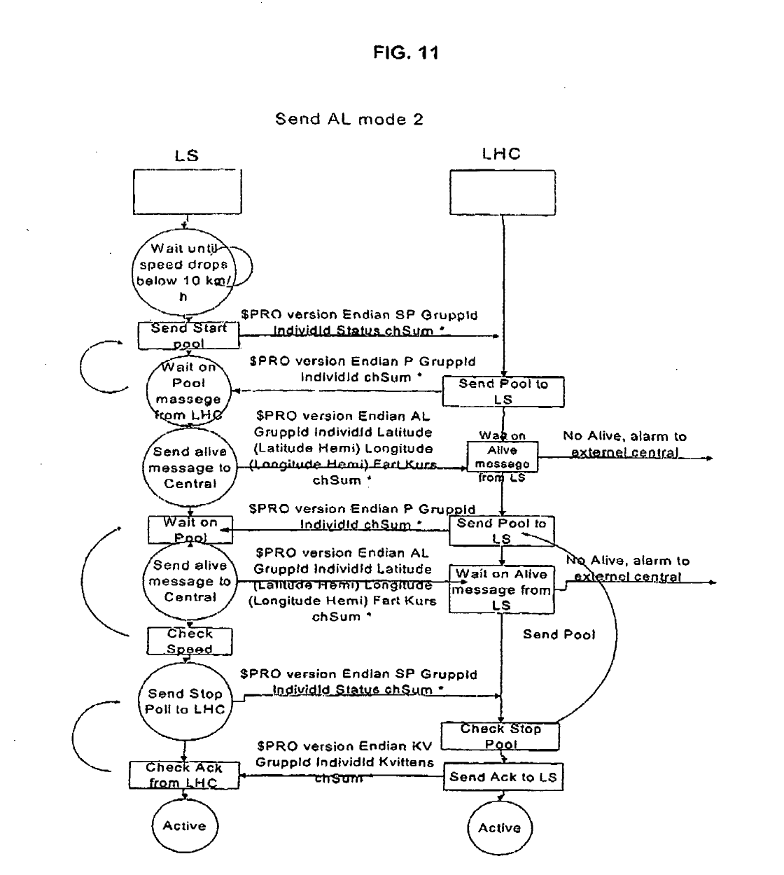

FIG. 11 shows the same flow as in FIG. 10 in Mode 2,

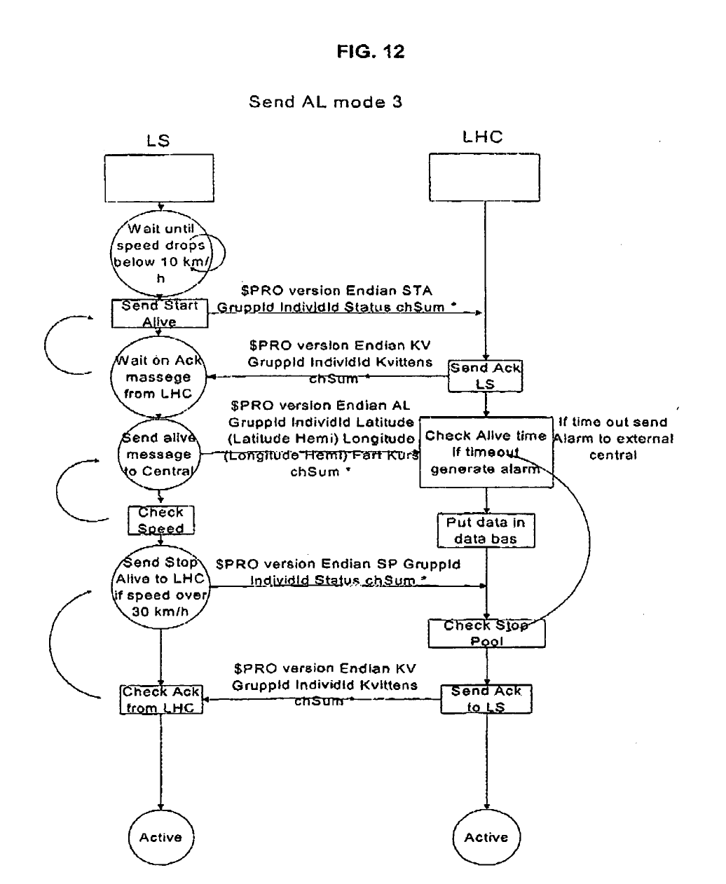

FIG. 12 shows the same flow as in FIG. 10 in Mode 3,

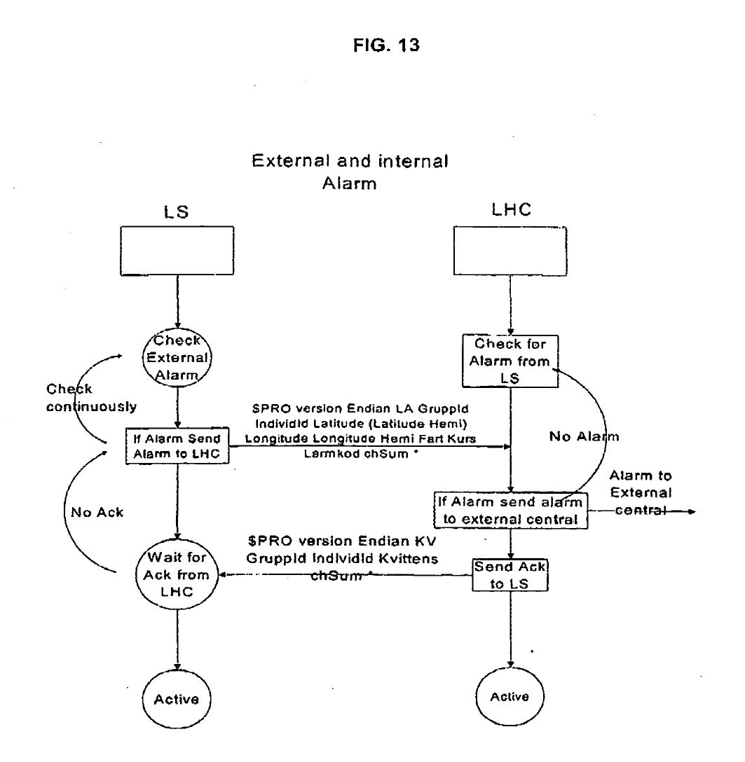

FIG. 13 shows the same flow as in FIG. 12 at external and internal alarm,

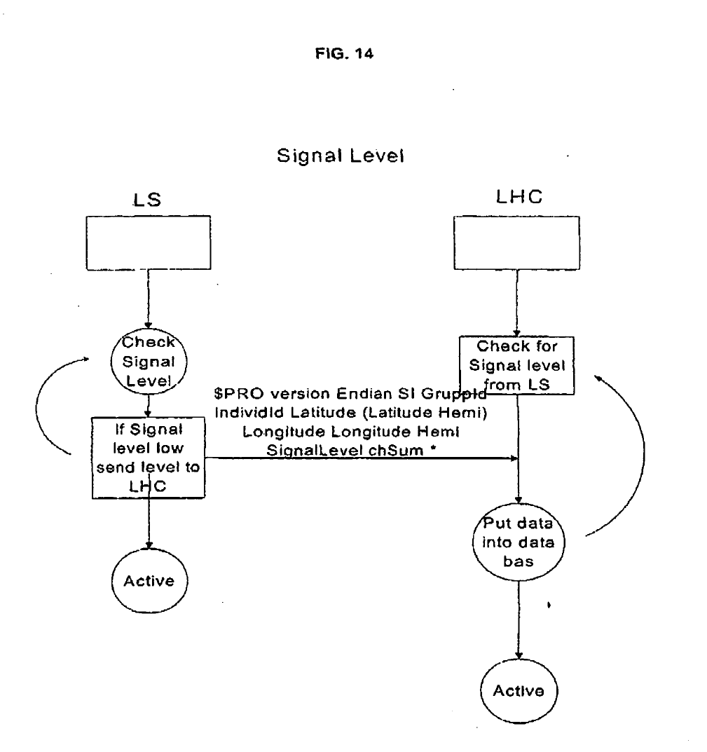

FIG. 14 shows data flow at signal level between the Mobile telephone alarm and the Alarm handling centre,

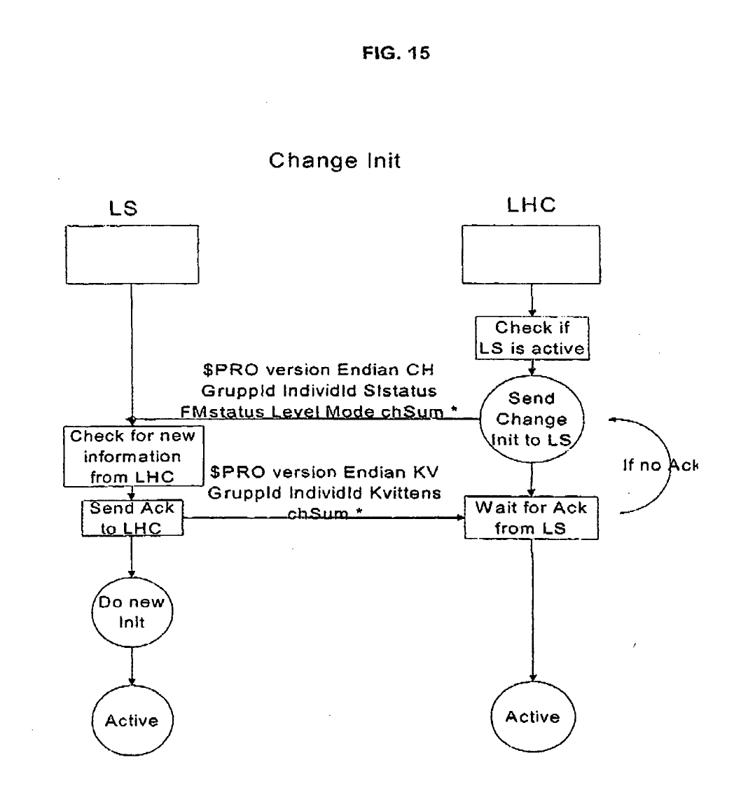

FIG. 15 shows data flow at alteration of initiation from the Mobile telephone alarm to the Alarm handling centre,

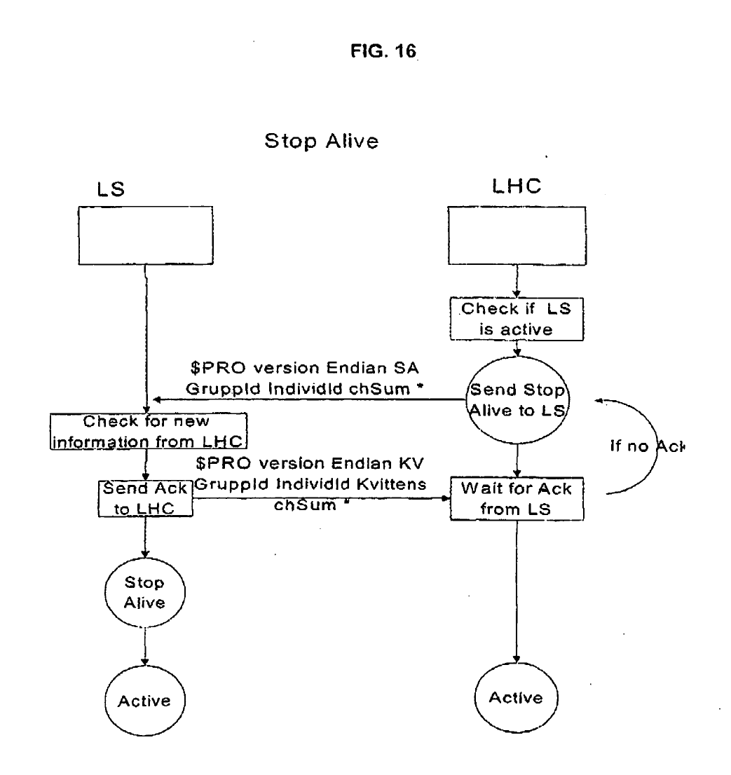

FIG. 16 shows data flow stop from the Mobile telephone alarm to the Alarm handling centre,

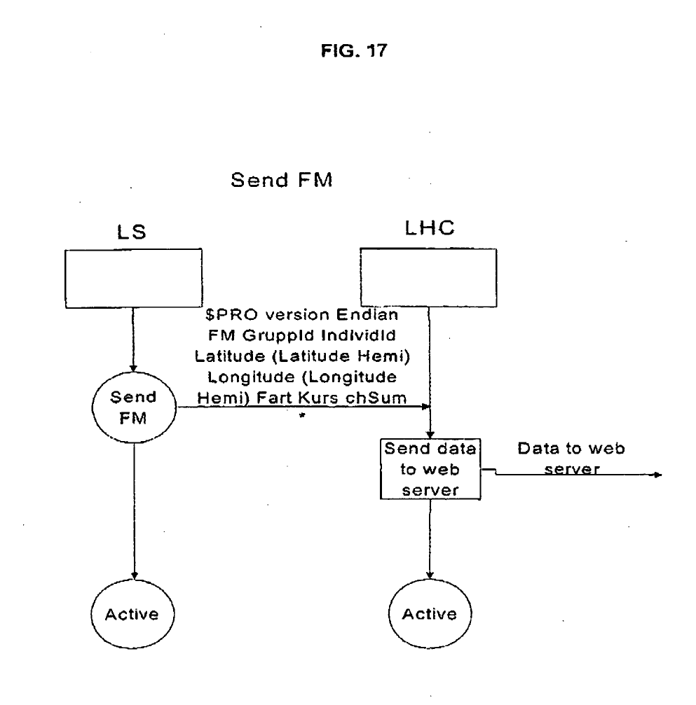

FIG. 17 shows data flow FM from the Mobile telephone alarm to the Alarm handling centre,

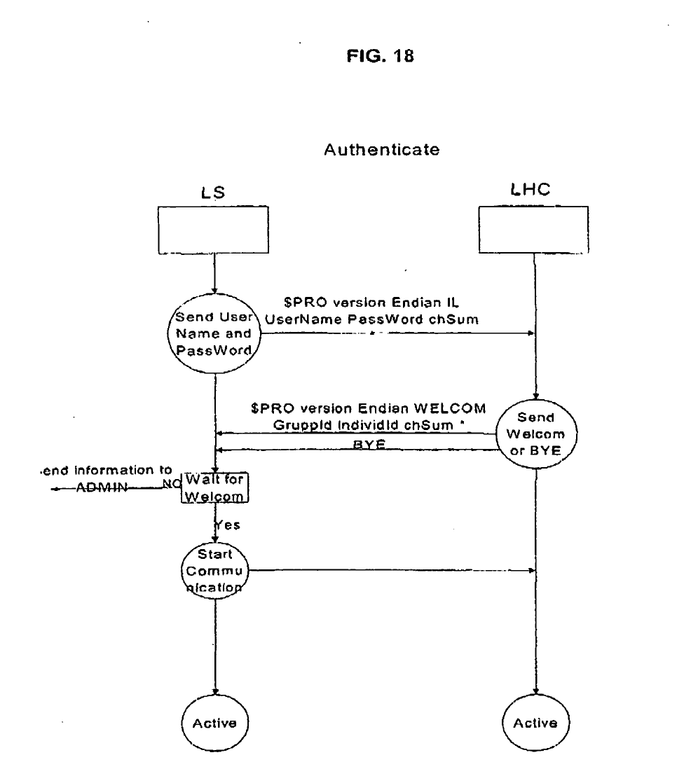

FIG. 18 shows data flow at logging in,

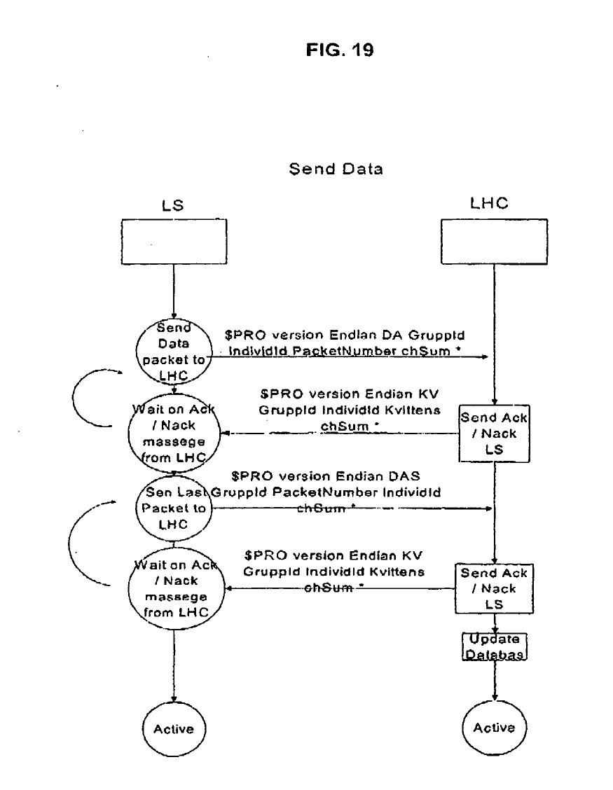

FIG. 19 shows data flow at data transmission,

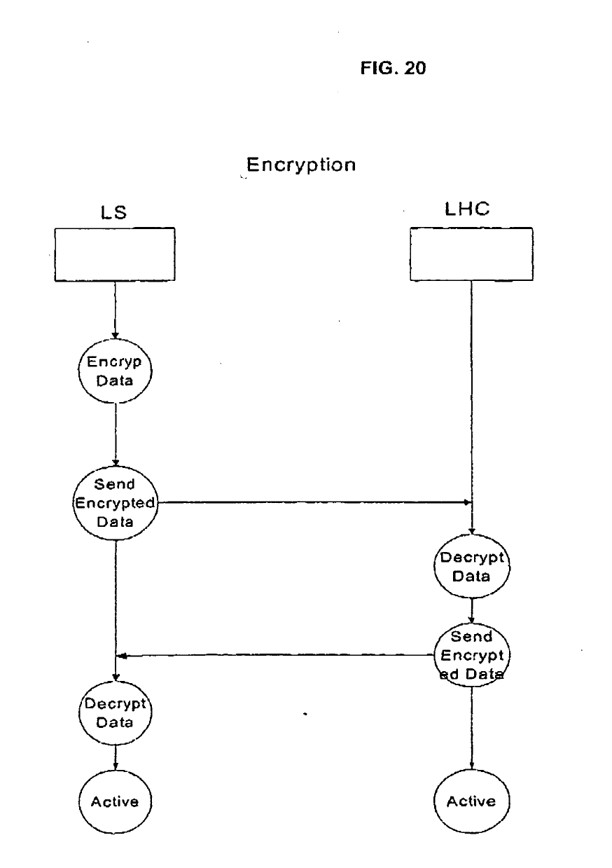

FIG. 20 shows data low at encryption,

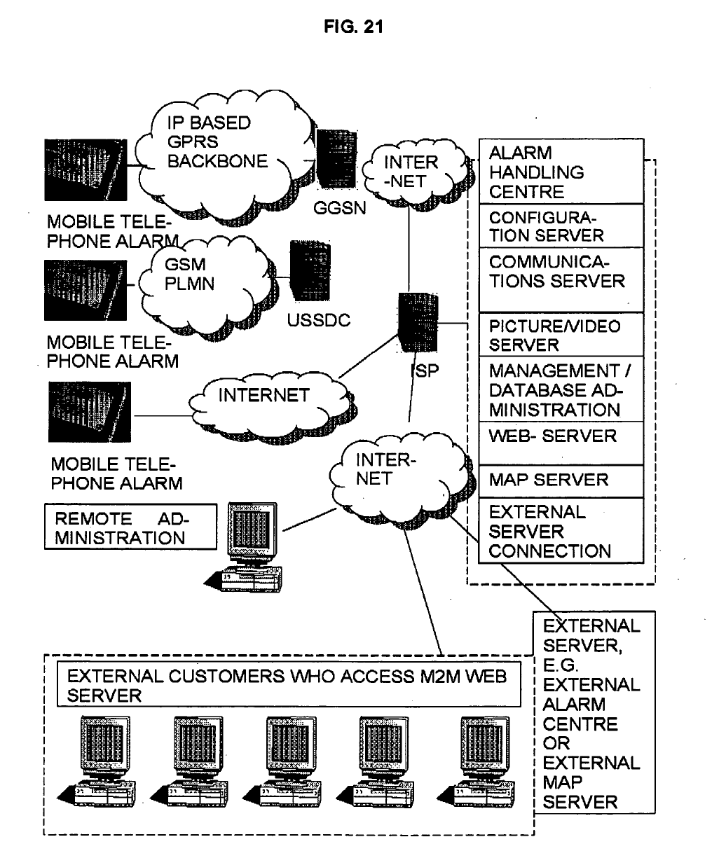

FIG. 21 shows a complete system,

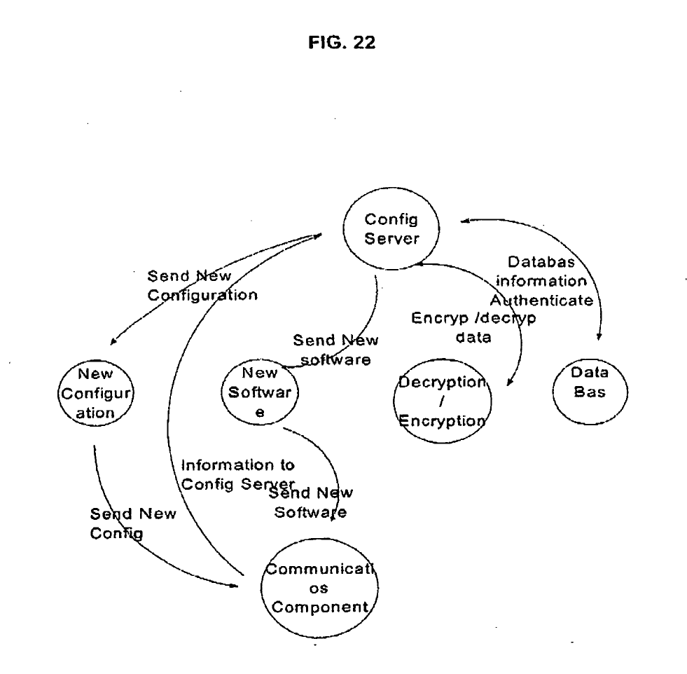

FIG. 22 shows processes in configuration server,

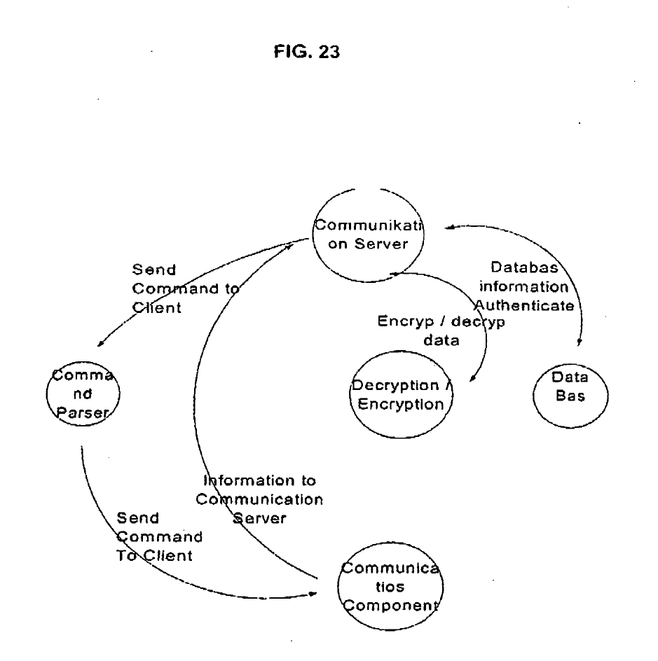

FIG. 23 shows processes in communications server,

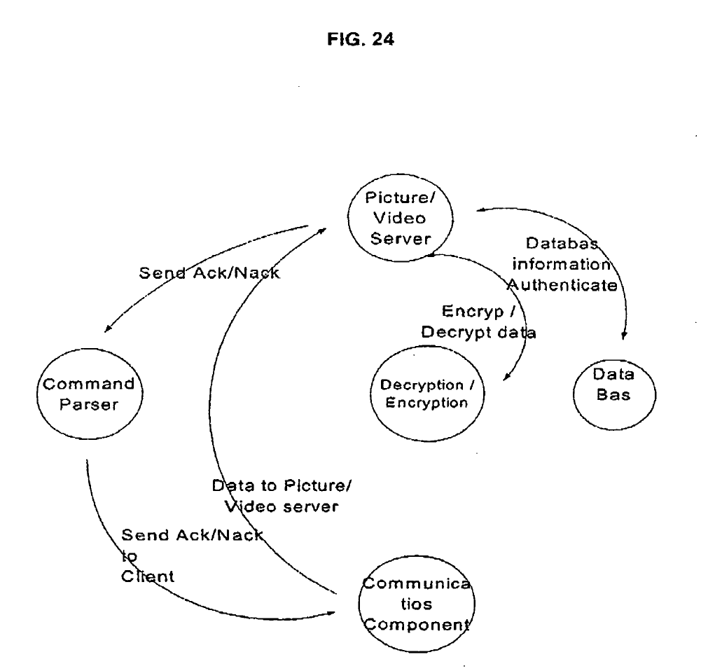

FIG. 24 shows processes in picture/video server,

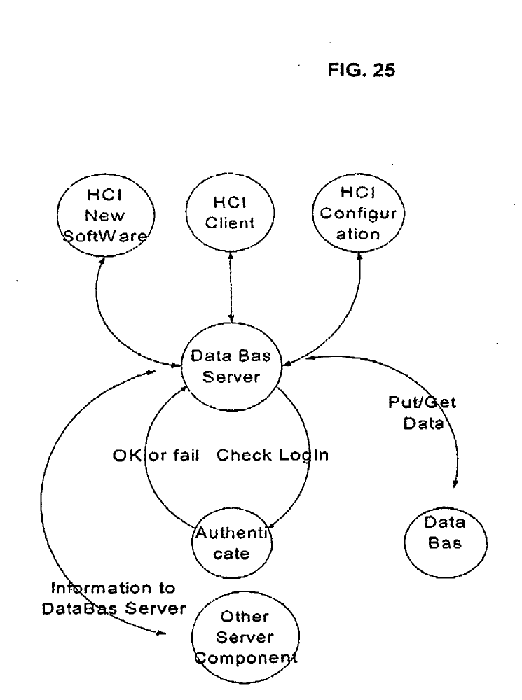

FIG. 25 shows processes in management/database handling,

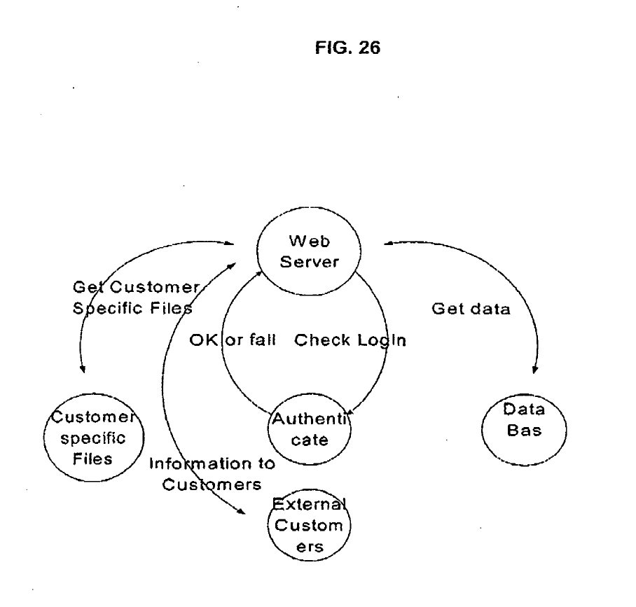

FIG. 26 shows processes in web server,

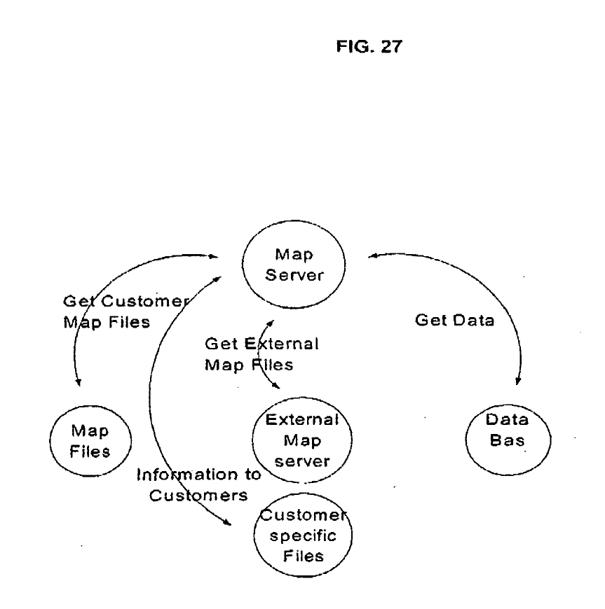

FIG. 27 shows processes in map server,

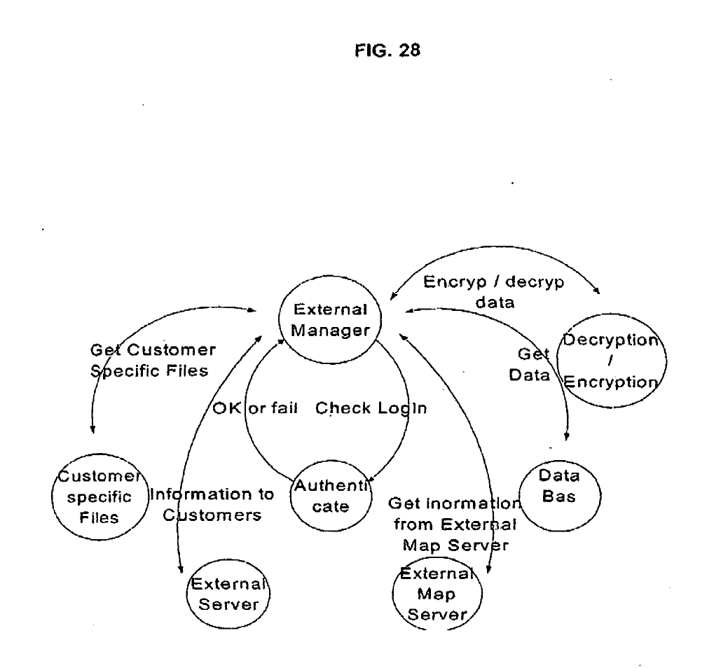

FIG. 28 shows processes at connection of external server,

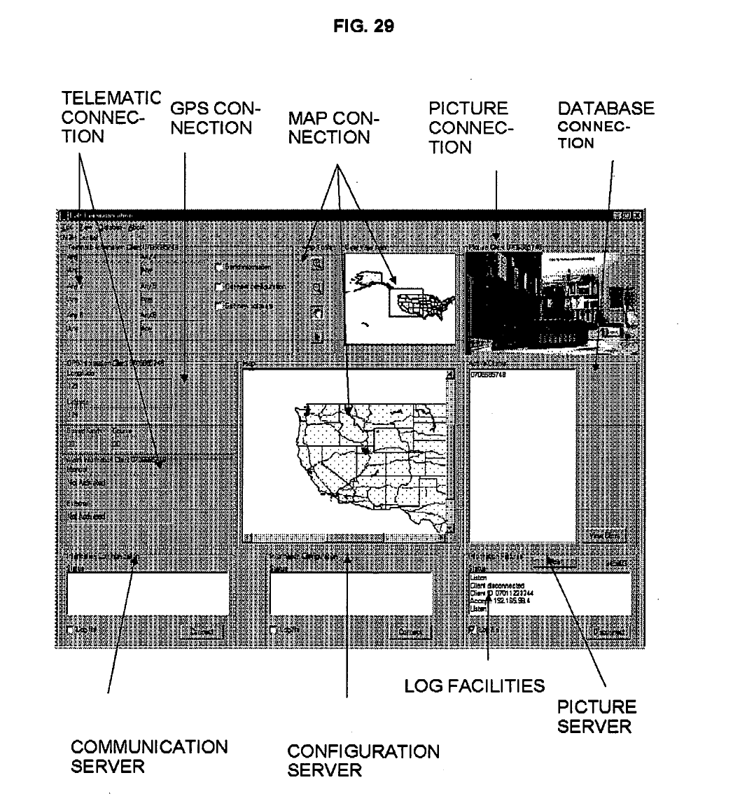

FIG. 29 shows a user interface for the application,

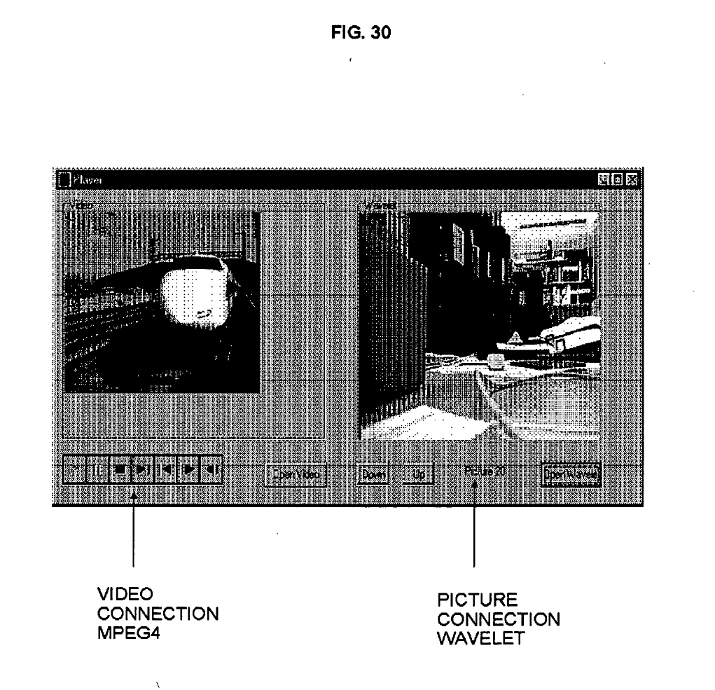

FIG. 30 shows a user interface for picture/video, and

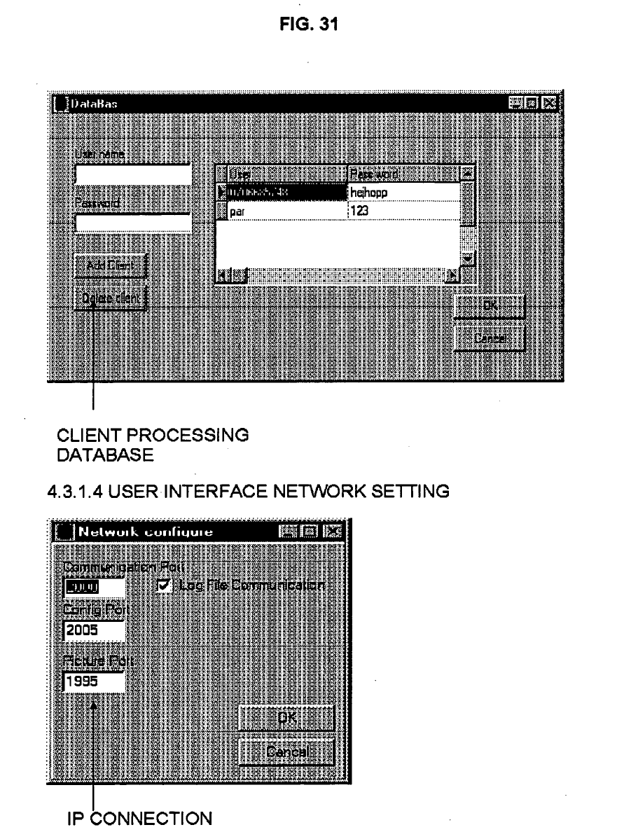

FIG. 31 shows user interface for database and network setting.

A list of abbreviations used in the following text is provided in Appendix A. Possible data media include those listed in Appendix B.

USSD

USSD is a message in the mobile telephone network, e.g. a USSD message is used when forwarding a telephone number. The USSD message is closely related to SMS, the difference being that SMS is sent from MS to MS whereas USSD is sent from MS to PLMN or from PLMN to MS. This means that USSD is a message in the PLMN network. A USSD message can be sent at any time since it uses a different channel from speech/data traffic and USSD messages cannot therefore be disturbed by calling to the mobile telephone alarm.

USSD is suitable for use as a watchdog message, i.e. a message can be sent to the centre at certain predetermined intervals stating that one is alive. If these messages cease it means that the mobile telephone alarm may have been thrown out or has ceased sending USSD messages for some other reason, and an alarm shall then be generated in the central unit. USSD messages shall include the ID of the user and data as to position.

The USSD Flow in the PLMN System

For a USSD message to be generated it must be generated by a user or a computer via MS or the central unit.

FIG. 1 shows an example of how USSD messages are processed by PLMN. PLMN contains MS, MSC/VLR and HLR (External node). No USSDC gateway therefore exists in a modern PLMN.

When MS sends a USSD message, therefore, VLR will receive it. VLR identifies the message and if it is addressed to HLR it will send it there. HLR detects that the USSD message is to be sent to an external node.

The gateway accepts the messages and sends the USSD/watchdog message to the central unit via TCP/IP, E-mail or PSTN.

The central unit can send USSD messages to MS. The central unit, for instance, shall be able to initiate the intervals at which the mobile telephone alarm shall send USSD messages.

GPRS

GPRS is an upgrading of the existing GSM networks. This means that data will travel in separate data channels and speech will travel in the old GSM network.

GPRS enables data links with short connection time. Data will be transported with IP (packet-forwarded technology) and the quantity of data transmitted will determine the cost. With the present GSM network the cost depends on connection time which means that it costs even if no data is transmitted.

One is hooked up the whole time with GPRS but is charged only for the quantity of data transmitted.

The GPRS Flow in the PLMN System

The new nodes are an SGSN which utilizes the system's HLR but is otherwise independent of the MSC. The task of the SGSN is to put packet data out on the Internet. This occurs via an IP connection with the other new node GGSN which is in contact via an IP or ATM network with the Internet or Intranet where our central unit receives the Watchdog messages. The GPRS flow in a PLMN system is shown in FIG. 2.

FIG. 3 shows an overall diagram of the arrangement with Mobile telephone alarm:
The mobile telephone alarm consists of an MS which supports GSM data and GPRS, computer and positional information equipment.

PLMN: The system will make use of the existing PLMN.

Gateway: The USSDC Gateway or GGSN is the connection between PLMN and Internet/PSTN. The gateway will receive USSD messages or IP traffic from PLMN and forward these to the central unit.

Alarm Handling Centre:
The centre receives USSD messages or packets via IP traffic containing watchdog information from Gateway and controlling which mobile telephone alarms have sent in watchdog messages. An alarm shall be generated if a Mobile telephone alarm ceases to send in its watchdog messages. The centre shall be able to initiate the mobile telephone alarm specifying, for instance, how often a watchdog message shall be generated by the mobile telephone alarm.

Mobile Telephone Alarm

The mobile telephone alarm is a unit whose main purpose is to send in an Alive message to an Alarm handling centre (LHC) If the Mobile telephone alarm ceases to send in its message the Alarm handling centre shall generate an alarm.

If necessary, the driver shall be able to generate an alarm, external alarm devices shall be able to generate alarms.

If the customer wishes to have Fleet management (FM) the Mobile telephone alarm shall generate FM messages. These messages have no security, i.e. if one of these messages disappears no alarm measures shall be taken.

The system will have 5 different security levels.
The level 1 Mobile telephone alarm sends in an Alive message every 12 hours.
The level 2 Mobile telephone alarm sends in an Alive message once every hour.
The level 3 Mobile telephone alarm sends in an Alive message every 10 minutes.
The level 4 Mobile telephone alarm sends in an Alive message once a minute.
The level 5 Mobile telephone alarm sends in an Alive message continuously.

The alarm handling centre has the details of which security level each

Mobile telephone alarm has and during which times the Mobile telephone alarm will be active.

When starting up the Mobile telephone alarm the sender shall request the Alarm handling centre to initiate the Mobile telephone alarm with the security level the Mobile telephone alarm shall have.

The primary task of the Mobile telephone alarm is to generate Alive messages with positional information.

The tasks of the Mobile telephone alarm can be divided into sub-tasks:

| | |
|---|---|
| Initiation | (Init Handler) |
| Process positional data from GPS | (GPS Component) |
| Generate Alive messages continuously or | (Speed Engine) |
| if a certain condition is fulfilled, e.g. if the | |
| speed falls below a certain level | |
| Generate Alive messages on request | (Alive Engine) |
| Generate fleet management | (FM Engine) |
| Control external alarm | (Alarm Component) |
| Control signal level | |
| Generate alarm from manual alarm or | (Alarm Component) |
| from an external alarm unit | |
| Process information from the Alarm | (Comm. Component) |
| handling centre | |

The Mobile telephone alarm can be initiated as follows and the Mobile telephone alarm may be in four modes:

Mode 0

MODE 0, LS sends in only FM messages.

Mode 1

After initiation the Mobile telephone alarm continuously sends Alive messages. Fleet management is optional. This mode is intended primarily for stationary Mobile telephone alarms.

Mode 2

MODE 2, if the vehicle is stationary or the average speed during one minute is less than 10 km/h, the Mobile telephone alarm sends a message to the Alarm handling centre that the Alarm handling centre can start pooling. Fleet management is optional. The Mobile telephone alarm must be stationary during initiation.

Mode 3

The Mobile telephone alarm is initiated to only send Alive messages when the speed of the vehicle is below 10 km/h and to cease sending Alive messages when the average speed of the vehicle has been more than 30 km/h for one minute. When the average speed of the vehicle exceeds 30 km/h for one minute the Mobile telephone alarm sends in a message to the Alarm handling centre that the Mobile telephone alarm will stop sending Alive messages. The Mobile telephone alarm sends the message to the Alarm handling centre, which sends an acknowledgement. The Alarm handling centre sends the acknowledgement until the Mobile telephone alarm has stopped sending that it will cease to send Alive messages. The Mobile telephone alarm must be stationary during initiation.

Initiation Message:

#PRO version Endian IN GruppId IndividId SIstatus FMstatus Level Mode chSum*

The SI parameter shall be set if the Mobile telephone alarm is to send in the signal level of the mobile telephone module.

SIstatus=0=off.

SIstatus=0 =off.

The FM parameter shall be set if the Mobile telephone alarm shall send in fleet management messages and at which intervals the Mobile telephone alarm shall send FM messages.

FMstatus=0=off.

FMstatus=1-255=on. (1-255 indicates how often the Mobile telephone

FMstatus=1-255 =on. (1-255 indicates how often the Mobile telephone

The MODE parameter is used to set which mode the Mobile telephone alarm shall be in.

MODE=0,1,2,3.

The LEVEL parameter is used to set which security level the Mobile telephone alarm shall be in.

LEVEL=0-255 indicates which security level the Mobile telephone alarm shall be in.

A description now follows of how information from GPS is processed.

The GPS sends its information via RS 232. The protocol used by the GPS is NMEA. In the NMEA protocol it is possible to choose between various GPS strings, e.g. $GPRMC is suitable for obtaining positional data. The GPS shall supply the Mobile telephone alarm with positional data in WGS 84 LatLong.

$GPRMC, <1>,<2>,<3>,<4>,<5>,<6>,<7>,<8>,<9>,<10>,<11>,<12>*hh<CR><LF>
1 UTC time in hhmmss
2 Status A=valid position V=NAV warning
2 Status A=valid position V=NAV warning
4 Latitude hemisphere N or S
5 Longitude dddmm,mmmm
6 Longitude hemisphere N or S
7 Speed in knots
8 course in degrees
9 UTC date
10 magnetic variation
11 magnetic variation direction
12 Mode
CRC

An Alive message can be generated according to Mode 1. Upon initiation, the Mobile telephone alarm receives information as to which mode the Mobile telephone alarm shall be in.
Mode 1, The Mobile telephone alarm sends in Alive messages continuously.

If the Mobile telephone alarm is initiated in Mode 1 it will be advised by the Alarm handling centre at what intervals it shall send in the message and whether the Mobile telephone alarm shall send in Alive messages continuously or if the speed falls below 10 km/h.

Start, Stop Alive message is built up in accordance with the following protocol.

$PRO version Endian STA GruppId IndividId Status chSum*

Status=0=Mobile telephone alarm stops sending Alive messages.

Status=1=Mobile telephone alarm starts sending Alive messages.

The Alive message is built up in accordance with the following protocol.

$PRO version Endian AL GruppId IndividId Latitude (Latitude Hemi) Longitude (Longitude Hemi) Speed Course chSum*

The acknowledgement message from the Alarm handling centre is built up in accordance with the following protocol. For the acknowledgement to be valid Acknowledgement shall correspond to 0x0A in both directions.

$PRO version Endian Ack GruppId IndividId Acknowledgement chSum*

Alive messages can be generated in accordance with Mode 2. At initiation the Mobile telephone alarm receives information as to which mode the Mobile telephone alarm shall be in.
Mode 2, The Mobile telephone alarm sends in the message when the Alarm handling centre asks for it.

If the speed of the vehicle falls below 10 km/h the Mobile telephone alarm sends a message to the Alarm handling centre that the Alarm handling centre shall start pooling the Mobile telephone alarm. The Mobile telephone alarm sends the message until the Alarm handling centre has started pooling. When the Alarm handling centre has starting pooling the Mobile telephone alarm interprets this as an acknowledgement and stops sending StartPool.

When the average speed of the vehicle exceeds 30 km/h for one minute the Mobile telephone alarm sends a message to the Alarm handling centre for the Alarm handling centre to stop pooling the Mobile telephone alarm. The Mobile telephone alarm sends the message until the Alarm handling centre sends an acknowledgement. The Alarm handling centre sends the acknowledgement until the Mobile telephone alarm has stopped sending StopPool.

The Pooling message from the Mobile telephone alarm to the Alarm handling centre is built up in accordance with the following protocol.

$PRO version Endian SP GruppId IndividId Status chSum*

Status=0=Stop pooling

Status=1=Start pooling.

The Pooling message from the Alarm handling centre to the Mobile telephone alarm is built up in accordance with the following protocol.

$PRO version Endian P GruppId IndividId Status chSum*

The Alive message is built up in accordance with the following protocol.

$PRO version Endian AL GruppId IndividId Latitude (Latitude Hemi) Longitude (Longitude Hemi) Speed Course chSum*

The acknowledgement message from the Alarm handling centre is built up

In accordance with the following protocol. For the acknowledgement to be valid Acknowledgement shall correspond to 0x0B.

$PRO version Endian Ack GruppId IndividId Acknowledgement chSum*

Generation of Alive messages in accordance with Mode 3. At initiation the Mobile telephone alarm receives information as to which mode the Mobile telephone alarm shall be in.
Mode 1, The Mobile telephone alarm sends in the Alive message if the speed falls below 10 km/h.

If the Mobile telephone alarm is initiated in Model it is informed by the Alarm handling centre at what intervals it shall send in the message and whether the Mobile telephone alarm shall send in Alive messages continuously or if the speed falls below 10 km/h.

The following applies when the Mobile telephone alarm is initiated to send in Alive messages only if the speed of the vehicle falls below the limit:

If the speed of the vehicle falls below 10 km/h the Mobile telephone alarm sends a message to the Alarm handling centre for it to start sending Alive messages. The Mobile telephone alarm sends the message until the Alarm handling centre sends acknowledgement. The Alarm handling centre sends acknowledgements until the Mobile telephone alarm starts sending Alive messages. When the Mobile telephone alarm has started sending Alive messages the Alarm handling centre interprets this as an acknowledgement and stops sending acknowledgements.

When the average speed of the vehicle exceeds 30 km/h for one minute the Mobile telephone alarm sends a message that it will stop sending Alive messages. The Mobile telephone alarm sends these messages and the Alive message until the Alarm handling centre sends an acknowledgement. The Alarm handling centre sends acknowledgements until the Mobile telephone alarm has stopped sending the Alive message and that it will stop sending the Alive message.

The Start, Stop Alive message is built up in accordance with the following protocol.

$PRO version Endian STA GruppId IndividId Status chSum*

Status=0=Mobile telephone alarm stops sending Alive.

Status=1=Mobile telephone alarm starts sending Alive.

The Alive message is built up in accordance with the following protocol.

$PRO version Endian AL GruppId IndividId Latitude (Latitude Hemi) Longitude (Longitude Hemi) Speed Course chSum*

The acknowledgement message from the Alarm handling centre is built up in accordance with the following protocol. For the acknowledgement to be valid Acknowledgement shall correspond to 0x0A in both directions.

$PRO version Endian Ack GruppId IndividId Acknowledgement chSum*

Control of External Alarms

If an external unit sends an alarm, e.g. a cover alarm, an external alarm message shall be generated and send to the alarm centre. When an external alarm has been activated the Mobile telephone alarm sends in the alarm message continuously once a minute until an acknowledgement has been received from the Alarm handling centre.

An external alarm message is built up in accordance with the following protocol.

$PRO version Endian LA GruppId IndividId Latitude (Latitude Hemi) Longitude (Longitude Hemi) Speed Course Alarm code chSum*

Alarm code 0x80-0xFF.

The acknowledgement message from the Alarm handling centre is built up in accordance with the following protocol. For the acknowledgement to be valid Acknowledgement shall correspond to the Alarm code.

$PRO version Endian Ack GruppId IndividId Acknowledgement chSum*

Generation of Alarm Through Manual Alarm

If the client is in some kind of danger the client shall be able to raise an alarm. The Mobile telephone alarm shall check whether an external alarm button has been activated. If the alarm button is activated the Mobile telephone alarm shall send in the alarm message once a minute until the Alarm handling centre has acknowledged the alarm.

A manual alarm message is built up in accordance with the following protocol.

$PRO version Endian LA GruppId IndividId Latitude (Latitude Hemi) Longitude (Longitude Hemi) Speed Course Alarm code chSum*

Alarm code 0x80-0xFF.

The acknowledgement message from the Alarm handling centre is built up in accordance with the following protocol. For the acknowledgement to be valid Acknowledgement shall correspond to the Alarm code.

$PRO version Endian Ack GruppId IndividId Acknowledgement chSum*

Control of Signal Level

If the Mobile telephone alarm has been initiated to send in its receiving signal level from the mobile telephone module, the Mobile telephone alarm shall continuously check the signal level of the transmitter. If the signal level falls below a certain level a message shall be sent to the Alarm handling centre. The function enables a database to be constructed concerning the extent of the PLMN network.

A signal level message is built up in accordance with the following protocol.

$PRO version Endian SI GruppId IndividId Latitude (Latitude Hemi) Longitude (Longitude Hemi) SignalLevel chSum*

SignalLevel=0x00-0xFF.

Processing Information for the Alarm Handling Centre

The configuration server in the Alarm handling centre initiates the Mobile telephone alarm at start-up. The Mobile telephone alarm then receives information as to which mode and security level it shall be in contact with.

When the Mobile telephone alarm communicates with the Alarm handling centre, the Alarm handling centre can give commands to the Mobile telephone alarm, e.g. for the Mobile telephone alarm to contact the configuration server to alter the initiation.

Initiation Mode:

When the Mobile telephone alarm is started it sends a message to the Configuration server in the Alarm handling centre that it is to be initiated. The Mobile telephone alarm sends the message until the Alarm handling centre sends the initiation message. The Alarm handling centre sends the initiation message until the Mobile telephone alarm starts sending the Alive message or sends a message that the Alarm handling centre can pool the Mobile telephone alarm. The Alarm handling centre interprets this as an acknowledgement and stops sending the initiation message.

A Get in it message from the Mobile telephone alarm to the Alarm handling centre is built up in accordance with the following protocol.

$PRO version Endian GI GruppId IndividId chSum*

The initiating message from the Alarm handling centre is built up in accordance with the following protocol.

$PRO version Endian IN GruppId IndividId SIstatus FMstatus Level Mode chSum*

See the communication flow in FIG. 9, Data flow between the Mobile telephone alarm and the Alarm handling centre.

Alteration of Initiation

The Alarm handling centre can change the initiation as follows:

The Alarm handling centre can increase the security levels in the Mobile telephone alarm but it cannot decrease the security levels when the Mobile telephone alarm is initiated. The Alarm handling centre can close or open FM messages. The Alarm handling centre can stop or start the Mobile telephone alarm sending its signal level.

The Alarm handling centre sends the alteration of initiation message to the Mobile telephone alarm once a minute until the Mobile telephone alarm sends in an acknowledgement. The Mobile telephone alarm sends acknowledgement once a minute until the Alarm handling centre has ceased to send the alteration of initiation message.

An alteration of initiation message is built up in accordance with the following protocol.

$PRO version Endian CH GruppId IndividId SIstatus FMstatus Level Mode chSum*.

The acknowledgement message is built up in accordance with the following protocol.

$PRO version Endian Ack GruppId IndividId Acknowledgement chSum*

Increase security Acknowledgement=0x0C.

Stop FM acknowledgement=0x0D.

Start FM acknowledgement=0x0F.

Stop signal level Acknowledgement=0x10.

Start signal level Acknowledgement=0x11.

Stop Alive Message:

The Alarm handling centre has information as to which times the Mobile telephone alarm shall send Alive messages. When the Mobile telephone alarm has passed its stop time the Alarm handling centre sends a message every minute for the Mobile telephone alarm to cease sending information. The Mobile telephone alarm sends an acknowledgement message that the Mobile telephone alarm has received the stop message until the Alarm handling centre stops sending the Stop Alive message.

The Stop Alive message is built up in accordance with the following protocol.

$PRO version Endian SA GruppId IndividId chSum*

The acknowledgement message is built up in accordance with the following protocol.

$PRO version Endian Ack GruppId IndividId Acknowledgement chSum*

The Stop Alive acknowledgement=0x12.

Generation of FM Messages.

Upon initiation the Mobile telephone alarm receives information as to whether it shall send FM messages and at what intervals.

The FM message is built up in accordance with the following protocol. $PRO version Endian FM GruppId IndividId Latitude (Latitude Hemi) Longitude (Longitude Hemi) Speed Course chSum*

Logging In

All communication between the Mobile telephone alarm and the Alarm handling centre occurs after the Mobile telephone alarm has logged into the Alarm handling centre. If the Mobile telephone alarm is unable to log in it shall send an e-mail to the system administrator. The Alarm handling centre shall log in all unsuccessful logging in attempts.

Data Flow Transmission

When the Mobile telephone alarm is to transmit large quantities of data, e.g. a picture or a video sequence, the Mobile telephone alarm will contact the Picture/video server in the Alarm handling centre. The Mobile telephone alarm transmits data and packet number to the Alarm handling centre which sends the packet number as Ack or 0x00 as Nack. If the Mobile telephone alarm receives a Nack the packet will be transmitted again. A stop packet is sent to the Alarm handling centre when the Mobile telephone alarm has finished transmitting data.

Encryption

All communication between the Mobile telephone alarm and the Alarm handling centre is encrypted. Encryption keys are distributed when the Mobile telephone alarm is manufactured.

Gateway

The task of the Gateway is to transmit data between different parts of the network, e.g. between PLMN and the Internet.

Gateway USSD

USSD messages are only in the PLMN network. A message can be sent from the mobile telephone to the network or from the PLMN network to the mobile telephone. The PLMN network must be supplemented with a

USSDC to enable a message to be sent from the mobile telephone to an Alarm handling centre

USSDC's task is to receive PLMN's USSD messages and forward these to the Alarm handling centre.

Gateway GPRS

A gateway between GPRS PLMN (GGSN) and the Internet exists in GPPRS. The GGSN's task is to forward IP packets to be sent via the Internet.

The GGSN's task is to receive IP packets from the Mobile telephone alarm and send them to the Alarm handling centre.

The Alarm Handling Centre

The task of the Alarm handling centre is to monitor that the Mobile telephone alarm sends in Alive messages. If one or more the Mobile telephone alarms ceases to send Alive messages the Alarm handling centre shall generate an alarm to an external centre.

The Alarm handling centre has a web interface where external customers can obtain data about their clients. The central has access to maps so that external customers can see where their objects are located on a digital map.

The centre may consist of eight different main processors.
Configuration server
Communication server
Picture/video server
Management/Database processing
Web server
Map server
External server connection.

The Alarm handling centre and web server may be physically in the same place whereas it is advisable for External central units to be situated physically in a different place.

The Alarm handling centre may physically be in an Intranet with high security. The web server is suitably in its own Intranet (DMZ), separate from the Alarm handling centre.

Configuration Server

The task of the configuration server is to initiate the Mobile telephone alarm and to upgrade the software in the Mobile telephone alarm if a new software version is available.

When the Mobile telephone alarm is started for the first time it has no information as to which Alarm handling centres it shall communicate with. The Mobile telephone alarm only has information as to which configuration server it shall contact. When the Mobile telephone alarm contacts the configuration server it receives information as to which Alarm handling centre and the behaviour of the Mobile telephone alarm.

Communication with the Communication server starts when the Mobile telephone alarm has received its configuration. The communication server can give commands for it to contact the configuration server for a new configuration or that the Mobile telephone alarm shall collect a new software version from the configuration server.

For data flows, please refer to

Initiation of the Mobile telephone alarm on page 7, FIG. 9

Data flow logging in on page 18, FIG. 18

Communication Server

The task of the communication server is to communication with the Mobile telephone alarm and to update the information in the database.

When the Mobile telephone alarm is connected to the Alarm handling centre, the Alarm handling centre can give the Mobile telephone alarm various commands, e.g. stop Alive, collect new configuration, collect new software, etc.

For data flow between the Mobile telephone alarm and the Communication server, please refer to:

Data flow Alive messages mode 1 between the Mobile telephone alarm and the Alarm handling centre on page 9, FIG. 10

Data flow Alive messages mode 2 between the Mobile telephone alarm and the Alarm handling centre on page 10, FIG. 11

Data flow Alive messages mode 3 between the Mobile telephone alarm and the Alarm handling centre on page 12, FIG. 12

Data flow external and internal alarms between the Mobile telephone alarm and the Alarm handling centre”on page 13, FIG. 13

Data flow Signal Level between the Mobile telephone alarm and the Alarm handling centre“on page 14, FIG. 14

Data flow Alteration of initiation between the Mobile telephone alarm and the Alarm handling centre on page 16, FIG. 15

Data flow logging in”on page 17, FIG. 18.

Picture/Video Server

The task of the picture/video is to receive picture/video data from the Mobile telephone alarm. The data flow can be seen under the heading Data flow data transmission on page 18, FIG. 19.

Management/Database Processing

The database processor can be used to add/remove clients from the system and to change their configuration data.

Web Server

Through the web server external customers can access data relating to their Mobile telephone alarms and see where the Mobile telephone alarms are via a digital map.

Map Server

The task of the map server is to show, via a digital map, where the Mobile telephone alarms are. By logging in, external customers shall be able to see where their Mobile telephone alarms are and if any of them has sent an alarm signal.

APPENDIX A

Abbreviations

BSC Base Station Controller

BTS Base transceiver Station

CM Communication Management

DMZ De-Militarised Zone

EDGE Enhanced Data rate of GSM Evolution

GPRS General Packet Radio Service

GGSN Gateway GPRS Supported Node

HLR Home Location Register

IP Internet Protocol

LS Alarm transmitter (Mobile telephone alarm)

LHC Alarm Handling Centre

MS Mobile Station

MMI Man Machine Interface

MMS Multimedia Messaging Service

MSC Mobile Services Switching Centre

PLMN Public Land Mobile Network

PSTN Public Switched Telephone Network

SMS Short Message Service

SGSN Serving GPRS Support Node

TTEN Transparent Transfer to External Node

TCP Transport Control Protocol

USSD Unstructured Supplementary Service Data

UMTS Universal Mobile Telephone System (3G)

VLR Visiting Location Register

APPENDIX B

Feasible data carriers for the Watchdog message are, for instance:
SMS
MMS
GSM Data conversations
Radio (e.g. Mobitex, DAB)
GPRS
EDGE
UMTS
USSD
MPS

1. An arrangement in a mobile communication system for transmitting an information signal from a mobile telephone or other unit having similar capabilities, to an optional communication system such as an internet system and in that case to a predetermined information unit, characterized in that one or more of the mobile telephones continuously emits a signal such as a USSD signal that is characteristic for each mobile telephone, in that a transmitting device is applied between the central unit of the mobile system and the Internet system, and in that the information unit triggers an indication in the absence of information signal.

2. An arrangement as claimed in claim 1, characterized in that the information signal includes affiliation data and may include positional data from an optional position system.

3. An arrangement as claimed in claim 1, characterized in that the mobile telephone or other unit having similar capabilities that emits the signal comprises a unit that generates the continuous information signal.

4. An arrangement as claimed in claim 3, characterized in that the unit procures positional data for each mobile telephone.
